(19) United States
(12) Patent Application Publication
(10) Pub. No.: US 2023/0022959 A1
(43) Pub. Date: Jan. 26, 2023

(54) DETECTING CRITICAL REGIONS AND PATHS IN THE CORE NETWORK FOR APPLICATION-DRIVEN PREDICTIVE ROUTING

(71) Applicant: Cisco Technology, Inc., San Jose, CA (US)

(72) Inventors: Sambarta DASGUPTA, Sunnyvale, CA (US); Vinay Kumar KOLAR, San Jose, CA (US); Jean-Philippe VASSEUR, Saint Martin d’Uriage (FR)

(21) Appl. No.: 17/380,235

(22) Filed: Jul. 20, 2021

(51) Int. Cl. H04L 12/26

(52) U.S. Cl. CPC H04L 43/065; H04L 43/0876

(57) ABSTRACT

In one embodiment, a device obtains quality of experience metrics for an online application. The device generates a mapping between network paths traversed by traffic of the online application and the quality of experience metrics. The device identifies a core entity along the network paths that is responsible for degradation of the quality of experience metrics. The device sends an alert regarding the core entity, whereby the alert causes the traffic of the online application to avoid the core entity.

### TECHNICAL FIELD

The present disclosure relates generally to computer networks, and, more particularly, to detecting critical regions and paths in the core network for application-driven predictive routing.

### BACKGROUND

Software-as-a-Service (SaaS) applications are usually deployed across the globe in different data centers. Users from different regions connect via core Internet links to these SaaS applications. Hence, the application experience of a user of a SaaS application depends on a number of different points of failure: the endpoint device of the user, their Local Area Network (LAN), the core Internet, the SaaS endpoint/data center, etc. Accordingly, troubleshooting poor SaaS application experience to trigger corrective measures (e.g., rerouting the application traffic) with such a wide array of possible components interacting with each other is challenging.

The dynamic aspect of SaaS connectivity also poses additional changes with respect to troubleshooting poor application experiences. For example, users from the same region may connect to different SaaS endpoints or data centers at different times. The service providers and autonomous systems on the way may present different network quality of service (QoS) at different times. If there is a problem in one of the arterial paths in the core Internet, the severity of the problem is significant and will widely affect a large number of users connecting to possibly a large number of SaaS data centers.

### BRIEF DESCRIPTION OF THE DRAWINGS

The embodiments herein may be better understood by referring to the following description in conjunction with the accompanying drawings in which like reference numerals indicate identically or functionally similar elements, of which:

FIGS. 1A-1B illustrate an example communication network;

FIG. 2 illustrates an example network device/node;

FIGS. 3A-3B illustrate example network deployments;

FIGS. 4A-4B illustrate example software defined network (SDN) implementations;

FIG. 5 illustrates an example architecture for detecting core entities responsible for degradation of application quality of experience (QoE) metrics;

FIG. 6 illustrates an example plot of different core entities;

FIG. 7 illustrates an example plot of application experience vs. entity centrality; and

FIG. 8 illustrates an example simplified procedure for identifying a core entity that is responsible for degradation of QoE metrics for an application.

### DESCRIPTION OF EXAMPLE EMBODIMENTS

### Overview

According to one or more embodiments of the disclosure, a device obtains quality of experience metrics for an online application. The device generates a mapping between network paths traversed by traffic of the online application and the quality of experience metrics. The device identifies a core entity along the network paths that is responsible for degradation of the quality of experience metrics. The device sends an alert regarding the core entity, whereby the alert causes the traffic of the online application to avoid the core entity.

### Description

A computer network is a geographically distributed collection of nodes interconnected by communication links and segments for transporting data between end nodes, such as personal computers and workstations, or other devices, such as sensors, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), or synchronous digital hierarchy (SDH) links, or Powerline Communications (PLC) such as IEEE 61334, IEEE P1901.2, and others. The Internet is an example of a WAN that connects disparate networks throughout the world, providing global communication between nodes on various networks. The nodes typically communicate over the network by exchanging discrete frames or packets of data according to predefined protocols, such as the Transmission Control Protocol/Internet Protocol (TCP/IP). In this context, a protocol consists of a set of rules defining how the nodes interact with each other. Computer networks may be further interconnected by an intermediate network node, such as a router, to extend the effective “size” of each network.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), personal area networks (PANs), etc. Generally, size and cost constraints on smart object nodes (e.g., sensors) result in corresponding constraints on resources such as energy, memory, computational speed and bandwidth.

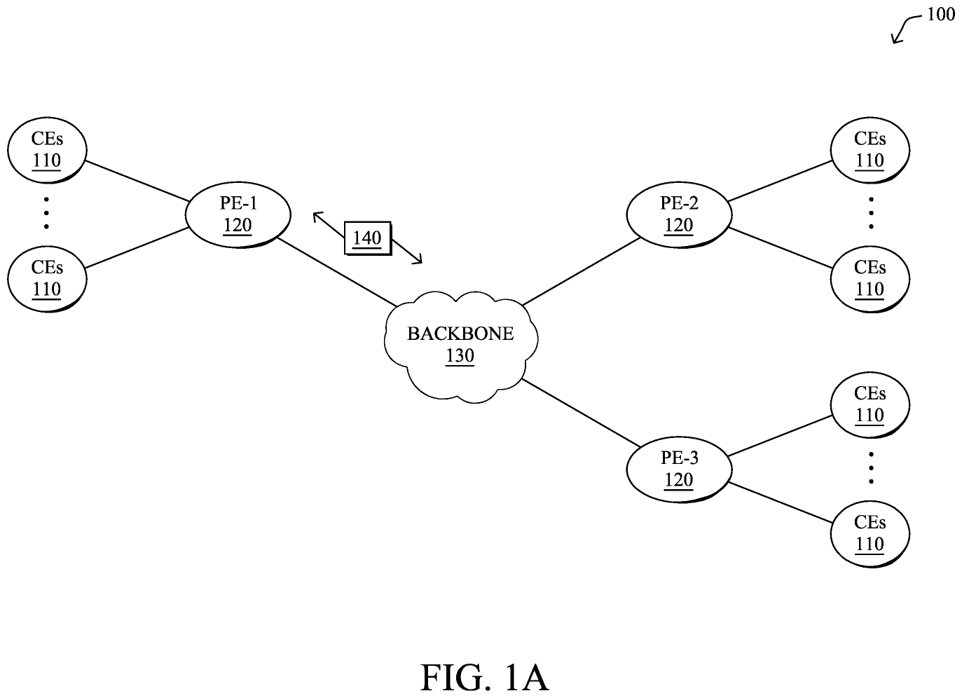

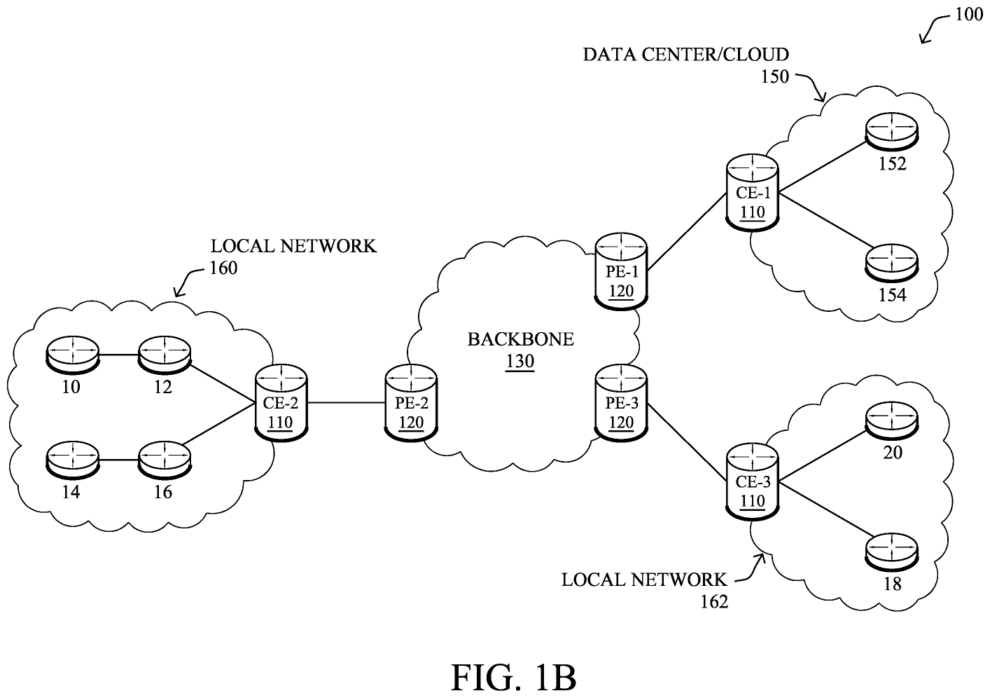

FIG. 1A is a schematic block diagram of an example computer network 100 illustratively comprising nodes/devices, such as a plurality of routers/devices interconnected by links or networks, as shown. For example, customer edge (CE) routers 110 may be interconnected with provider edge (PE) routers 120 (e.g., PE-1, PE-2, and PE-3) in order to communicate across a core network, such as an illustrative network backbone 130. For example, routers 110, 120 may be interconnected by the public Internet, a multiprotocol label switching (MPLS) virtual private network (VPN), or the like. Data packets 140 (e.g., traffic/messages) may be exchanged among the nodes/devices of the computer network 100 over links using predefined network communication protocols such as the Transmission Control Protocol/Internet Protocol (TCP/IP), User Datagram Protocol (UDP), Asynchronous Transfer Mode (ATM) protocol, Frame Relay protocol, or any other suitable protocol. Those skilled in the art will understand that any number of nodes, devices, links, etc. may be used in the computer network, and that the view shown herein is for simplicity.

In some implementations, a router or a set of routers may be connected to a private network (e.g., dedicated leased lines, an optical network, etc.) or a virtual private network (VPN), such as an MPLS VPN thanks to a carrier network, via one or more links exhibiting very different network and service level agreement characteristics. For the sake of illustration, a given customer site may fall under any of the following categories:

1.) Site Type A: a site connected to the network (e.g., via a private or VPN link) using a single CE router and a single link, with potentially a backup link (e.g., a 3G/4G/5G/LTE backup connection). For example, a particular CE router 110 shown in network 100 may support a given customer site, potentially also with a backup link, such as a wireless connection.

2.) Site Type B: a site connected to the network by the CE router via two primary links (e.g., from different Service Providers), with potentially a backup link (e.g., a 3G/4G/5G/LTE connection). A site of type B may itself be of different types:

2a.) Site Type B1: a site connected to the network using two MPLS VPN links (e.g., from different Service Providers), with potentially a backup link (e.g., a 3G/4G/5G/LTE connection).

2b.) Site Type B2: a site connected to the network using one MPLS VPN link and one link connected to the public Internet, with potentially a backup link (e.g., a 3G/4G/5G/LTE connection). For example, a particular customer site may be connected to network 100 via PE-3 and via a separate Internet connection, potentially also with a wireless backup link.

2c.) Site Type B3: a site connected to the network using two links connected to the public Internet, with potentially a backup link (e.g., a 3G/4G/5G/LTE connection).

Notably, MPLS VPN links are usually tied to a committed service level agreement, whereas Internet links may either have no service level agreement at all or a loose service level agreement (e.g., a “Gold Package” Internet service connection that guarantees a certain level of performance to a customer site).

3.) Site Type C: a site of type B (e.g., types B1, B2 or B3) but with more than one CE router (e.g., a first CE router connected to one link while a second CE router is connected to the other link), and potentially a backup link (e.g., a wireless 3G/4G/5G/LTE backup link). For example, a particular customer site may include a first CE router 110 connected to PE-2 and a second CE router 110 connected to PE-3.

FIG. 1B illustrates an example of network 100 in greater detail, according to various embodiments. As shown, network backbone 130 may provide connectivity between devices located in different geographical areas and/or different types of local networks. For example, network 100 may comprise local/branch networks 160, 162 that include devices/nodes 10-16 and devices/nodes 18-20, respectively, as well as a data center/cloud environment 150 that includes servers 152-154. Notably, local networks 160-162 and data center/cloud environment 150 may be located in different geographic locations.

Servers 152-154 may include, in various embodiments, a network management server (NMS), a dynamic host configuration protocol (DHCP) server, a constrained application protocol (CoAP) server, an outage management system (OMS), an application policy infrastructure controller (APIC), an application server, etc. As would be appreciated, network 100 may include any number of local networks, data centers, cloud environments, devices/nodes, servers, etc.

In some embodiments, the techniques herein may be applied to other network topologies and configurations. For example, the techniques herein may be applied to peering points with high-speed links, data centers, etc.

According to various embodiments, a software-defined WAN (SD-WAN) may be used in network 100 to connect local network 160, local network 162, and data center/cloud environment 150. In general, an SD-WAN uses a software defined networking (SDN)-based approach to instantiate tunnels on top of the physical network and control routing decisions, accordingly. For example, as noted above, one tunnel may connect router CE-2 at the edge of local network 160 to router CE-1 at the edge of data center/cloud environment 150 over an MPLS or Internet-based service provider network in backbone 130. Similarly, a second tunnel may also connect these routers over a 4G/5G/LTE cellular service provider network. SD-WAN techniques allow the WAN functions to be virtualized, essentially forming a virtual connection between local network 160 and data center/cloud environment 150 on top of the various underlying connections. Another feature of SD-WAN is centralized management by a supervisory service that can monitor and adjust the various connections, as needed.

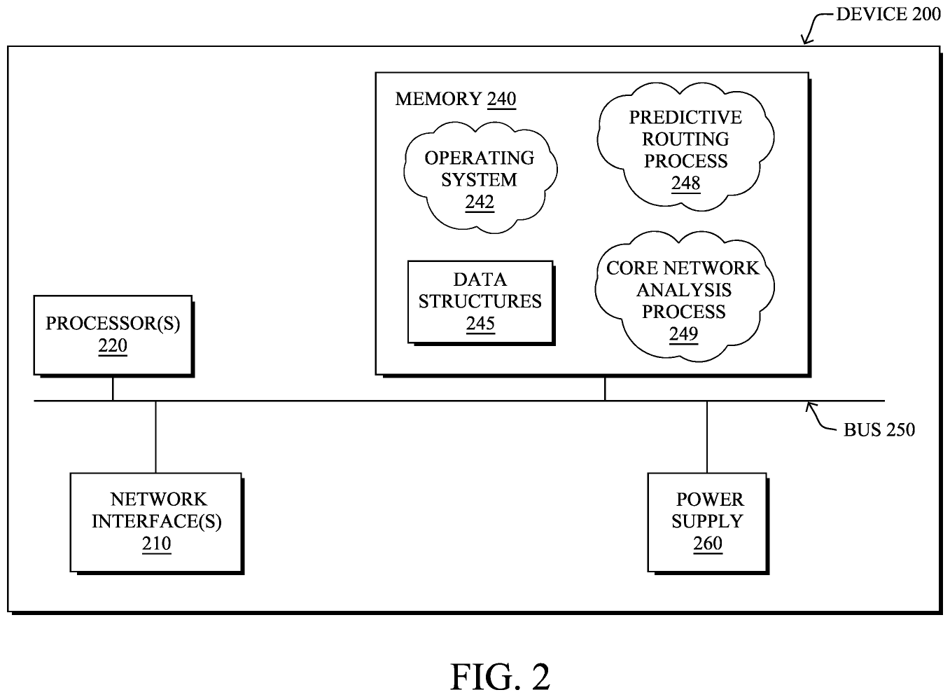

FIG. 2 is a schematic block diagram of an example node/device 200 (e.g., an apparatus) that may be used with one or more embodiments described herein, e.g., as any of the computing devices shown in FIGS. 1A-1B, particularly the PE routers 120, CE routers 110, nodes/device 10-20, servers 152-154 (e.g., a network controller/supervisory service located in a data center, etc.), any other computing device that supports the operations of network 100 (e.g., switches, etc.), or any of the other devices referenced below. The device 200 may also be any other suitable type of device depending upon the type of network architecture in place, such as IoT nodes, etc. Device 200 comprises one or more network interfaces 210, one or more processors 220, and a memory 240 interconnected by a system bus 250, and is powered by a power supply 260.

The network interfaces 210 include the mechanical, electrical, and signaling circuitry for communicating data over physical links coupled to the network 100. The network interfaces may be configured to transmit and/or receive data using a variety of different communication protocols. Notably, a physical network interface 210 may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a predictive routing process 248 and/or a core network analysis process 249, as described herein, any of which may alternatively be located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, predictive routing process 248 contains computer executable instructions executed by the processor 220 to perform routing functions in conjunction with one or more routing protocols. These functions may, on capable devices, be configured to manage a routing/forwarding table (a data structure 245) containing, e.g., data used to make routing/forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (e.g., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

In various embodiments, as detailed further below, predictive routing process 248 and/or a core network analysis process 249 may include computer executable instructions that, when executed by processor(s) 220, cause device 200 to perform the techniques described herein. To do so, in some embodiments, predictive routing process 248 and/or a core network analysis process 249 may utilize machine learning. In general, machine learning is concerned with the design and the development of techniques that take as input empirical data (such as network statistics and performance indicators), and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a,b,c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, predictive routing process 248 and/or a core network analysis process 249 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that predictive routing process 248 and/or a core network analysis process 249 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, consider the case of a model that predicts whether the QoS of a path will satisfy the service level agreement (SLA) of the traffic on that path. In such a case, the false positives of the model may refer to the number of times the model incorrectly predicted that the QoS of a particular network path will not satisfy the SLA of the traffic on that path. Conversely, the false negatives of the model may refer to the number of times the model incorrectly predicted that the QoS of the path would be acceptable. True negatives and positives may refer to the number of times the model correctly predicted acceptable path performance or an SLA violation, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

As noted above, in software defined WANs (SD-WANs), traffic between individual sites are sent over tunnels. The tunnels are configured to use different switching fabrics, such as MPLS, Internet, 4G or 5G, etc. Often, the different switching fabrics provide different QoS at varied costs. For example, an MPLS fabric typically provides high QoS when compared to the Internet, but is also more expensive than traditional Internet. Some applications requiring high QoS (e.g., video conferencing, voice calls, etc.) are traditionally sent over the more costly fabrics (e.g., MPLS), while applications not needing strong guarantees are sent over cheaper fabrics, such as the Internet.

Traditionally, network policies map individual applications to Service Level Agreements (SLAs), which define the satisfactory performance metric(s) for an application, such as loss, latency, or jitter. Similarly, a tunnel is also mapped to the type of SLA that is satisfies, based on the switching fabric that it uses. During runtime, the SD-WAN edge router then maps the application traffic to an appropriate tunnel. Currently, the mapping of SLAs between applications and tunnels is performed manually by an expert, based on their experiences and/or reports on the prior performances of the applications and tunnels.

The emergence of infrastructure as a service (IaaS) and software as a service (SaaS) is having a dramatic impact of the overall Internet due to the extreme virtualization of services and shift of traffic load in many large enterprises. Consequently, a branch office or a campus can trigger massive loads on the network.

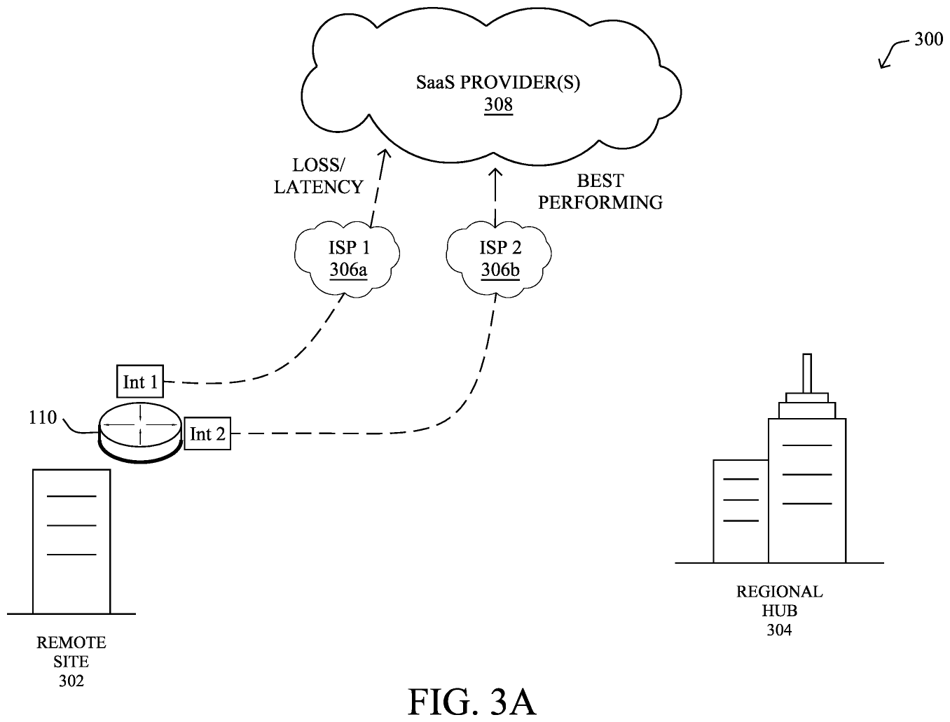

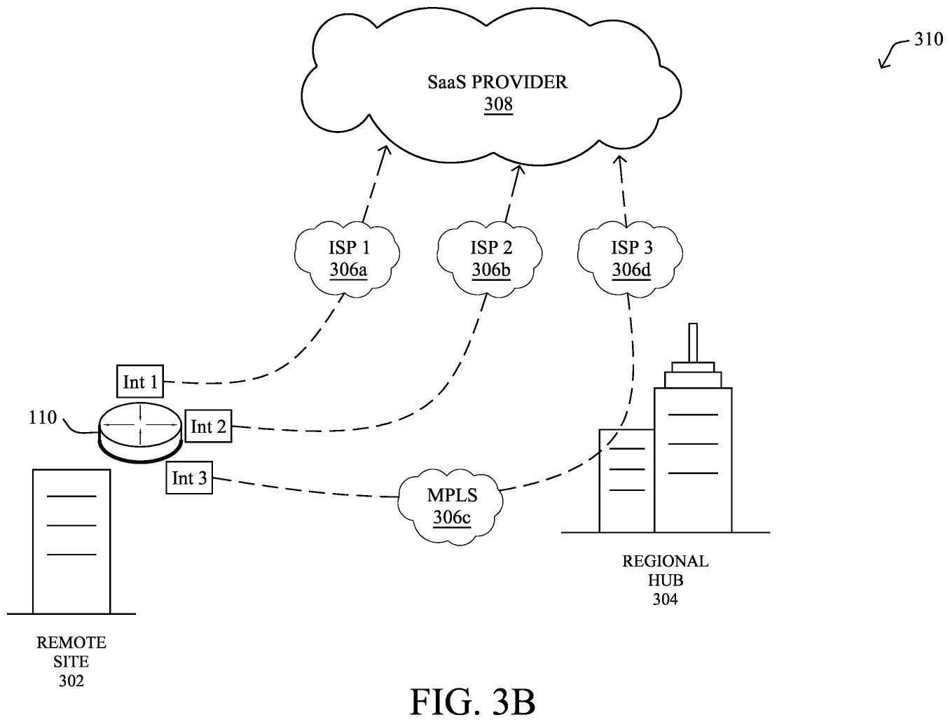

FIGS. 3A-3B illustrate example network deployments 300, 310, respectively. As shown, a router 110 located at the edge of a remote site 302 may provide connectivity between a local area network (LAN) of the remote site 302 and one or more cloud-based, SaaS providers 308. For example, in the case of an SD-WAN, router 110 may provide connectivity to SaaS provider(s) 308 via tunnels across any number of networks 306. This allows clients located in the LAN of remote site 302 to access cloud applications (e.g., Office 365™, Dropbox™, etc.) served by SaaS provider(s) 308.

As would be appreciated, SD-WANs allow for the use of a variety of different pathways between an edge device and a SaaS provider. For example, as shown in example network deployment 300 in FIG. 3A, router 110 may utilize two Direct Internet Access (DIA) connections to connect with SaaS provider(s) 308. More specifically, a first interface of router 110 (e.g., a network interface 210, described previously), Int 1, may establish a first communication path (e.g., a tunnel) with SaaS provider(s) 308 via a first Internet Service Provider (ISP) 306a, denoted ISP 1 in FIG. 3A. Likewise, a second interface of router 110, Int 2, may establish a backhaul path with SaaS provider(s) 308 via a second ISP 306b, denoted ISP 2 in FIG. 3A.

FIG. 3B illustrates another example network deployment 310 in which Int 1 of router 110 at the edge of remote site 302 establishes a first path to SaaS provider(s) 308 via ISP 1 and Int 2 establishes a second path to SaaS provider(s) 308 via a second ISP 306b. In contrast to the example in FIG. 3A, Int 3 of router 110 may establish a third path to SaaS provider(s) 308 via a private corporate network 306c (e.g., an MPLS network) to a private data center or regional hub 304 which, in turn, provides connectivity to SaaS provider(s) 308 via another network, such as a third ISP 306d.

Regardless of the specific connectivity configuration for the network, a variety of access technologies may be used (e.g., ADSL, 4G, 5G, etc.) in all cases, as well as various networking technologies (e.g., public Internet, MPLS (with or without strict SLA), etc.) to connect the LAN of remote site 302 to SaaS provider(s) 308. Other deployments scenarios are also possible, such as using Colo, accessing SaaS provider(s) 308 via Zscaler or Umbrella services, and the like.

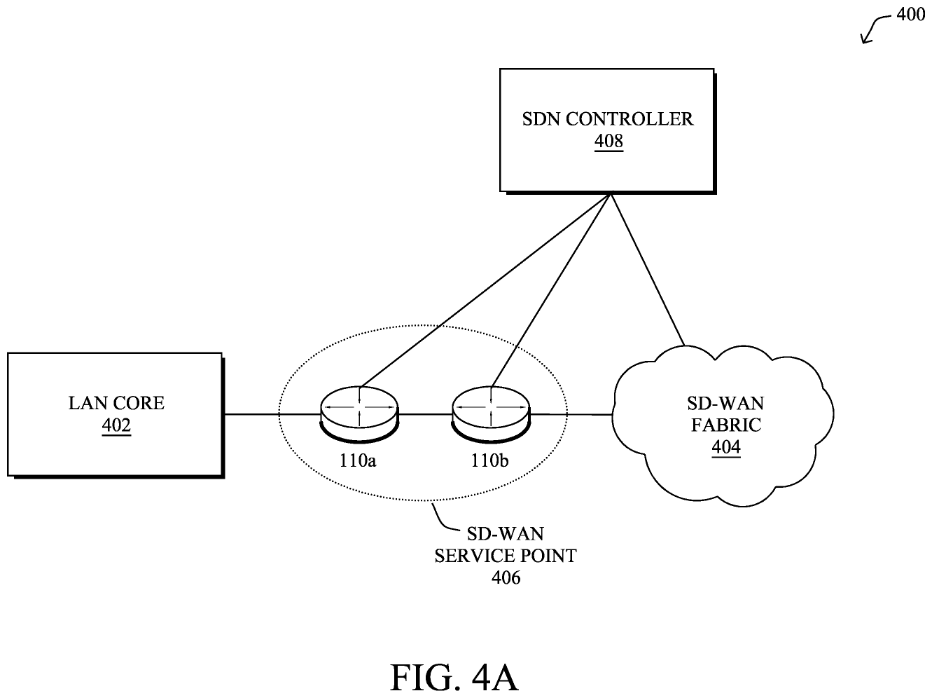

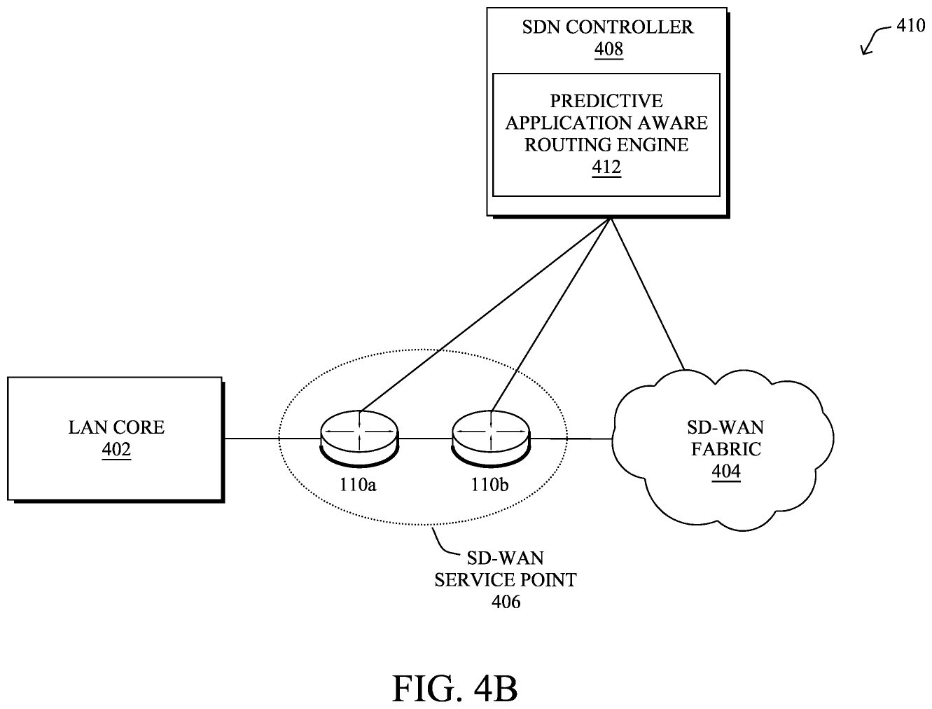

FIG. 4A illustrates an example SDN implementation 400, according to various embodiments. As shown, there may be a LAN core 402 at a particular location, such as remote site 302 shown previously in FIGS. 3A-3B. Connected to LAN core 402 may be one or more routers that form an SD-WAN service point 406 which provides connectivity between LAN core 402 and SD-WAN fabric 404. For instance, SD-WAN service point 406 may comprise routers 110a-110b.

Overseeing the operations of routers 110a-110b in SD-WAN service point 406 and SD-WAN fabric 404 may be an SDN controller 408. In general, SDN controller 408 may comprise one or more devices (e.g., a device 200) configured to provide a supervisory service, typically hosted in the cloud, to SD-WAN service point 406 and SD-WAN fabric 404. For instance, SDN controller 408 may be responsible for monitoring the operations thereof, promulgating policies (e.g., security policies, etc.), installing or adjusting IPsec routes/tunnels between LAN core 402 and remote destinations such as regional hub 304 and/or SaaS provider(s) 308 in FIGS. 3A-3B, and the like.

As noted above, a primary networking goal may be to design and optimize the network to satisfy the requirements of the applications that it supports. So far, though, the two worlds of “applications” and “networking” have been fairly siloed. More specifically, the network is usually designed in order to provide the best SLA in terms of performance and reliability, often supporting a variety of Class of Service (CoS), but unfortunately without a deep understanding of the actual application requirements. On the application side, the networking requirements are often poorly understood even for very common applications such as voice and video for which a variety of metrics have been developed over the past two decades, with the hope of accurately representing the Quality of Experience (QoE) from the standpoint of the users of the application.

More and more applications are moving to the cloud and many do so by leveraging a SaaS model, Consequently, the number of applications that became network-centric has grown approximately exponentially with the raise of SaaS applications, such as Office 365, ServiceNow, SAP, voice, and video, to mention a few. All of these applications rely heavily on private networks and the Internet, bringing their own level of dynamicity with adaptive and fast changing workloads. On the network side, SD-WAN provides a high degree of flexibility allowing for efficient configuration management using SDN controllers with the ability to benefit from a plethora of transport access (e.g., MPLS, Internet with supporting multiple CoS, LTE, satellite links, etc.), multiple classes of service and policies to reach private and public networks via multi-cloud SaaS.

Furthermore, the level of dynamicity observed in today's network has never been so high. Millions of paths across thousands of Service Provides (SPs) and a number of SaaS applications have shown that the overall QoS(s) of the network in terms of delay, packet loss, jitter, etc. drastically vary with the region, SP, access type, as well as over time with high granularity. The immediate consequence is that the environment is highly dynamic due to:
New in-house applications being deployed;
New SaaS applications being deployed everywhere in the network, hosted by a number of different cloud providers;
Internet, MPLS, LTE transports providing highly varying performance characteristics, across time and regions;
SaaS applications themselves being highly dynamic: it is common to see new servers deployed in the network. DNS resolution allows the network for being informed of a new server deployed in the network leading to a new destination and a potentially shift of traffic towards a new destination without being even noticed.

According to various embodiments, application aware routing usually refers to the ability to rout traffic so as to satisfy the requirements of the application, as opposed to exclusively relying on the (constrained) shortest path to reach a destination IP address. Various attempts have been made to extend the notion of routing, CSPF, link state routing protocols (ISIS, OSPF, etc.) using various metrics (e.g., Multi-topology Routing) where each metric would reflect a different path attribute (e.g., delay, loss, latency, etc.), but each time with a static metric. At best, current approaches rely on SLA templates specifying the application requirements so as for a given path (e.g., a tunnel) to be “eligible” to carry traffic for the application. In turn, application SLAs are checked using regular probing. Other solutions compute a metric reflecting a particular network characteristic (e.g., delay, throughput, etc.) and then selecting the supposed ‘best path,’ according to the metric.

The term ‘SLA failure’ refers to a situation in which the SLA for a given application, often expressed as a function of delay, loss, or jitter, is not satisfied by the current network path for the traffic of a given application. This leads to poor QoE from the standpoint of the users of the application. Modern SaaS solutions like Viptela, CloudonRamp SaaS, and the like, allow for the computation of per application QoE by sending HyperText Transfer Protocol (HTTP) probes along various paths from a branch office and then route the application's traffic along a path having the best QoE for the application. At a first sight, such an approach may solve many problems. Unfortunately, though, there are several shortcomings to this approach:
The SLA for the application is ‘guessed,’ using static thresholds.
Routing is still entirely reactive: decisions are made using probes that reflect the status of a path at a given time, in contrast pith the notion of an informed decision,
SLA failures are very common in the Internet and a good proportion of them could be avoided (e.g., using an alternate path), if predicted in advance.

In various embodiments, the techniques herein allow for a predictive application aware routing engine to be deployed, such as in the cloud, to control routing decisions in a network. For instance, the predictive application aware routing engine may be implemented as part of an SDN controller (e.g., SDN controller 408) or other supervisory service, or may operate in conjunction therewith. For instance, FIG. 4B illustrates an example 410 in which SDN controller 408 includes a predictive application aware routing engine 412 (e.g., through execution of predictive routing process 248). Further embodiments provide for predictive application aware routing engine 412 to be hosted on a router 110 or at any other location in the network.

During execution, predictive application aware routing engine 412 makes use of a high volume of network and application telemetry (e.g., from routers 110a-110b, SD-WAN fabric 404, etc.) so as to compute statistical and/or machine learning models to control the network with the objective of optimizing the application experience and reducing potential down times. To that end, predictive application aware routing engine 412 may compute a variety of models to understand application requirements, and predictably route traffic over private networks and/or the Interne (thus optimizing the application experience while drastically reducing SLA failures and downtimes.

In other words, predictive application aware routing engine 412 may first predict SLA violations in the network that could affect the QoE of an application (e.g., due to spikes of packet loss or delay, sudden decreases in bandwidth, etc.). In turn, predictive application aware routing engine 412 may then implement a corrective measure, such as rerouting the traffic of the application, prior to the predicted SLA violation. For instance, in the case of video applications, it now becomes possible to maximize throughput at any given time, which is of utmost importance to maximize the QoE of the video application. Optimized throughput can then be used as a service triggering the routing decision for specific application requiring highest throughput, in one embodiment. In general, routing configuration changes are also referred to herein as routing “patches,” which are typically temporary in nature (e.g., active for a specified period of time) and may also be application-specific (e.g., for traffic of one or more specified applications).

As noted above, SaaS applications are usually deployed across the globe in different data centers. Users from different regions connect via core Internet links to these SaaS applications. Hence, the application experience of a user of a SaaS application depends on a number of different points of failure: the endpoint device of the user, their LAN, the core Internet, the SaaS endpoint/data center, etc. Accordingly, troubleshooting poor SaaS application experience to trigger corrective measures (e.g., rerouting the application traffic) with such a wide array of possible components interacting with each other is challenging.

The dynamic aspect of SaaS connectivity also poses additional changes with respect to troubleshooting poor application experiences. For example, users from the same region may connect to different SaaS endpoints or data centers at different times. The service providers and autonomous systems on the way may present different network QoS at different times. If there is a problem in one of the arterial paths in the core Internet, the severity of the problem is significant and will widely affect a large number of users connecting to possibly a large number of SaaS data centers.

### Detecting Critical Regions and Paths in the Core Network for Application-Driven Predictive Routing

The techniques herein introduce system and methods to conjointly track the core connectivity entities, such as autonomous system nodes, edges, or sub-paths, and the application experience along such core components. In various aspects, the techniques herein can also root-cause bad application experience on core and non-core entities and raises alerts to both routing engines and SaaS data centers. The techniques herein further describe components of routing engines and SaaS data centers which receive such alerts and take appropriate corrective actions. For example, the routing engine or data center may choose to redirect sessions via a better path or to a totally different data center that avoids the possibly degraded paths.

Illustratively, the techniques described herein may be performed by hardware, software, and/or firmware, such as in accordance with core network analysis process 249, which may include computer executable instructions executed by the processor 220 (or independent processor of interfaces 210) to perform functions relating to the techniques described herein, e.g., in conjunction with predictive routing process 248.

Specifically, according to various embodiments, a device obtains quality of experience metrics for an online application. The device generates a mapping between network paths traversed by traffic of the online application and the quality of experience metrics. The device identifies a core entity along the network paths that is responsible for degradation of the quality of experience metrics. The device sends an alert regarding the core entity, whereby the alert causes the traffic of the online application to avoid the core entity.

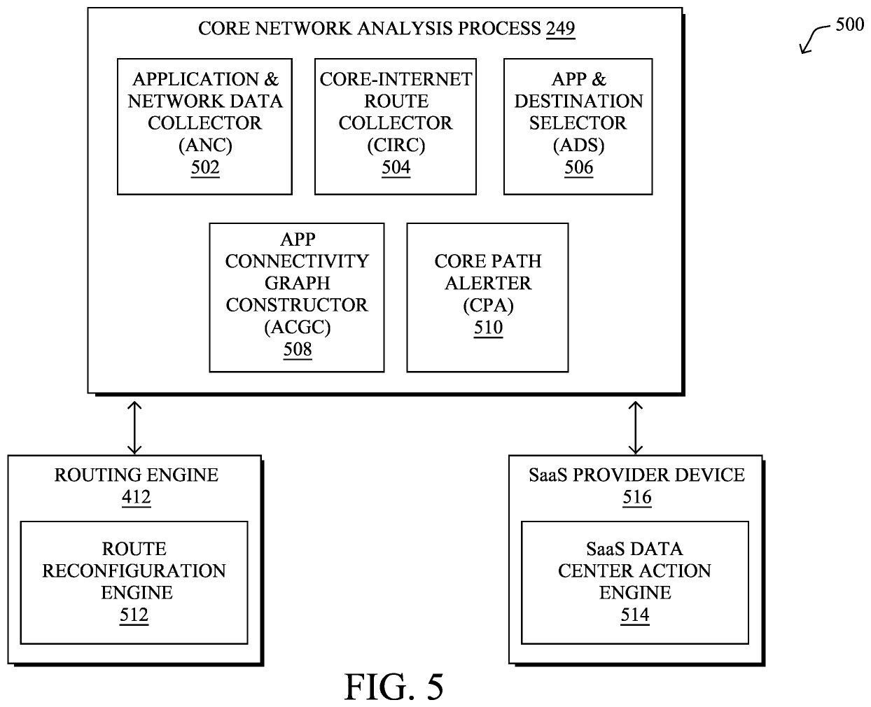

Operationally, FIG. 5 illustrates an example architecture 500 for detecting core entities responsible for degradation of application QoE metrics, according to various embodiments. At the core of architecture 500 is core network analysis process 249, which may be executed by a controller for a network or another device in communication therewith. For instance, core network analysis process 249 may be executed by a controller for a network (e.g., SDN controller 408 in FIGS. 4A-4B), a particular networking device in the network (e.g., a router, etc.), another device or service in communication therewith, or the like, to provide a supervisory service to the network. More specifically, core network analysis process 249 may operate in conjunction with a predictive application aware routing engine, such as predictive application aware routing engine 412, a SaaS Provider device 516, or directly implemented as a component thereof, in some embodiments.

As shown, core network analysis process 249 may include any or all of the following components: application and network data collector (ANC) 502, core-Internet route collector (CIRC) 504, application and destination selector (ADS) 506, application connectivity graph constructor (ACGC) 508, and/or core path alerter (CPA) 510. As would be appreciated, the functionalities of these components may be combined or omitted, as desired. In addition, these components may be implemented on a singular device or in a distributed manner, in which case the combination of executing devices can be viewed as their own singular device for purposes of executing core network analysis process 249.

During execution, application and network data collector (ANC) 502 is responsible for obtaining any or all of the following information:
Application QoE metrics—this can be obtained from the SaaS provider, such as via SaaS provider device 516, from the individual client devices that access the online application, or from other sources, either on a pull or push basis. In some instances, the QoE may be explicitly specified by the users of the application, such as via satisfaction surveys, a quality rating mechanism, or the like.
Network data—for instance, this may include Netflow or other network records for the various user sessions. Such information may indicate, for instance, the source and destinations of traffic flows for the application, QoS metrics for the traversed paths, etc.
Path trace data—this information can be obtained through various mechanisms, to trace the paths between the various user sites and application data centers.

In various embodiments, core-Internet route collector (CIRC) 504 may be responsible for collecting Border Gateway Protocol (BGP) data, to list the routes across the Internet. To do so, CIRC 504 may rely on any number of sources to ingest BGP routing tables from across the Internet. For instance, such sources may include, but are not limited to, any or all of the following: Route-view from the University of Oregon, RIPE Routing Information Service (RIS) from Réseaux IP Européens Network Coordination Centre (RIPE NCC), ThousandEyes and Crosswork from Cisco Systems, Inc., or the like. Each of these sources have multiple collectors which capture the BGP routing table, periodically (e.g., every 2 hours). More specifically, each collector may collect the data based on the destination in a table such as:
Timestamp—the time at which the route table was dumped
Source IP—the source IP of the collector node
Destination prefix—the destination IP and mask to reach from the collector
Paths—an array of next-hop and ordered list of autonomous system paths
   for instance: {Next_Hop (e.g., 12.0.1.63), AS_Path (e.g., [7018, 174, 61135, 42910)]

The BGP routes from different collectors are collected over time and provided to CIRC 504, which provides a routing table database with snapshots of the routing tables at each time.

The application-level paths from ACN 502 and the BGP routes from CIRC 504 may be stored by core network analysis process 249 in a common data model (CDM). In some embodiments, the CDM may take the form of a graph where multiple hyper-edges (paths) can have different metrics that vary over time. Using such a schema, it is easy to represent and match paths. For example, every path between an edge-router and a SaaS destination (used by the application traffic) can be mapped to the associated AS-path by mapping the AS associated with the edge-router to the AS associated with the SaaS endpoint to which the user is connected. An example CDM schema that core network analysis process 249 may use is as follows:
endpointId (string, mandatory): Unique identifier for the endpoint.
endpointType (string, mandatory): Type of the endpoint, which must be one of the following types:
edge router: used for edge routers
saas-dc: used to represent a SaaS data center for a given service
prefix: used to represent a routing prefix on the Internet. It is identified by the CIDR notation of the range specified by the field metadata.prefix. It must also contain the asn metadata.
asn: used to represent an autonomous system (AS)
lastSeen (timestamp, mandatory): Last timestamp where the endpoint was seen active. Depending on the endpoint type, this can be based on various type of information. The timestamp is not expected to be very precise (e.g., it can be a date).
Location (object): Geo-localization information about the endpoint. This structure includes the city, latitude, longitude and other location variables.
metadata (object): Free-form metadata about the endpoint. This includes:
systemIp (string): For edge routers, the system IP address of the router, which is not used for routing data plane traffic.
hostname (string): The hostname of the endpoint, when known. Available for routers, VPN clients, and SaaS endpoints.
siteId (string): The site identifier of this endpoint (for edge routers).
deviceModel (string): The device model of this endpoint (for edge routers).
asn (integer): For prefixes, the number of the AS that announces this prefix.
organization (string): The organization that owns or manages the endpoint.
prefixes (list[string]): The prefixes specified in CIDR notation associated to this entity. Available for routing prefixes of course (in which case the list contains only one element), but also SaaS data centers (to which multiple prefixes can be associated).
regionName: Region name of the cloud provider (e.g., for AWS, Azure, or WebEx data centers).
aggregatedBy (string): When set, indicates the aggregation granularity (e.g., location.city or metadata.service). In this case, the endpoint identifier must end with key=value (e.g., saas#metadata.service=webex for the aggregated endpoint that denotes all WebEx data centers in the world.)
   endpointId (string, mandatory): Unique identifier for the endpoint.
   endpointType (string, mandatory): Type of the endpoint, which must be one of the following types:
   Edge Router: used for edge routers
   saas-dc: used to represent a SaaS data center for a given service
   prefix: used to represent a routing prefix on the Internet. It is identified by the CIDR notation of the range specified by the field metadata.prefix. It must also contain the asn metadata.
   asn: used to represent an autonomous system (AS)
   lastSeen (timestamp, mandatory): Last timestamp where the endpoint was seen active. Depending on the endpoint type, this can be based on various type of information. The timestamp is not expected to be very precise (e.g., it can be a date).
   Location (object): Geo-localization information about the endpoint. This structure includes the city, latitude, longitude and other location variables.
   metadata (object): Free-form metadata about the endpoint. This includes:
   systemIp (string): For edge routers, the system IP address of the router, which is not used for routing data plane traffic.
   hostname (string): The hostname of the endpoint, when known. Available for routers, VPN clients, and SaaS endpoints.
   siteId (string): The site identifier of this endpoint (for edge routers).
   deviceModel (string): The device model of this endpoint (for edge routers).
   asn (integer): For prefixes, the number of the AS that announces this prefix.
   organization (string): The organization that owns or manages the endpoint.
   prefixes (list[string]): The prefixes specified in CIDR notation associated to this entity. Available for routing prefixes of course (in which case the list contains only one element), but also SaaS data centers (to which multiple prefixes can be associated).
   regionName: Region name of the cloud provider (e.g., for AWS, Azure, or WebEx data centers).
   aggregatedBy (string): When set, indicates the aggregation granularity (e.g., location.city or metadata.service). In this case, the endpoint identifier must end with key=value (e.g., saas#metadata.service=webex for the aggregated endpoint that denotes all WebEx data centers in the world.)

In various embodiments, application and destination selector (ADS) 506 may allow a user of core network analysis process 249 to specify what core network analysis process 249 is to monitor. For instance, a network administrator may specify critical application(s) to be monitored, SaaS destination(s) to monitor, specific locations to monitor, or the like. To assist in this, ADS 506 may also provide information to the user regarding the most commonly used applications and SaaS destinations in that network. For instance, ADS 506 may easily fetch this information by looking at NetFlow data obtained by ANC 502 and resolving the SaaS IP address to location by using IP-to-location databases such as ip2location or MaxMind. User may then select the set or subset of those applications to monitor. In other embodiments, the most commonly used SaaS applications and destinations across all network deployments can be added by ADS 506 to a common database, and users can be shown this global popular SaaS destinations along with the common ones used in their network.

According to various embodiments, application connectivity graph constructor (AGCG) 508 is responsible for constructing the routing graph at different points in time. This database is used to assess the probable routes taken to different destinations from different sources at different times. This graph can be constructed from data obtained by CIRC 504.

For instance, ACGC 508 may construct an “AS_Path” graph as a directed graph of routers which can be of the form “AS₁→ . . . →ASₖ→ . . . →ASₘ . . . →ASₙ,” where each ‘AS’ is a different autonomous system. Since BGP is a path-vector protocol, this vector of path also provides the sub-routes that are valid. For example, if a router has to reach ASₘ and the first AS encountered is ASₖ, then it can be assumed that the probable path traversed at that time is the sub-path “ASₖ→ . . . →ASₘ.” ACGC 508 may use this information to build the core connectivity graph, which depicts the connectivity across all AS that is measured by the collectors. The core connectivity graph, thus, is a directed graph connecting where each node is an AS and there is an edge between two AS: ASᵢ→ASⱼ if there was a hop in AS_Path between ASᵢ and ASⱼ.

In the next stage, ACGC 508 may build a connectivity graph for a specific application or SaaS endpoint. This graph is referred to herein as a SaaS End-point Connectivity Graph (SECG). For each SaaS endpoint, ACGC 508 may extract its possible IP prefix. For example, the IPs and prefixes for a datacenter may be extracted. This may be indicated by the SaaS application providers. Then a sub-graph of the core connectivity graph is constructed which have destination IP/prefix for that particular SaaS. Note that such sub-graphs can be built not only for SaaS applications, but can also be constructed for IaaS (e.g., “aws-eu-centrall-EC2”), as well. As a result, ACGC 508 may identify the core arterial connectivity using BGP routes.

In further embodiments, ACGC 508 may enhance the connectivity graph by adding several novel graph metrics to describe the importance of a node, an edge, or sub-paths. Examples of such metrics may include, but are not limited to, any or all of the following:
Centrality metrics for nodes: These metrics quantify the importance of the node with respect to a given weight of the node. In one embodiment, the weight of a node can be assigned to the number of paths that pass through that node. In other embodiments, ACGC 508 may use a centrality algorithm, such as Eigen centrality, Katz centrality, page-rank, or the like. For example, each node can be weighed by the degree and a centrality metric can be computed. Such a metric can be used to signify the importance of a node based on the number of other ASNs that it connects to and their importance. The more central a node is, the more ‘important’ it is in connecting different edge-routers to the given SaaS end-point.
Edge importance: Similar to node centrality, each edge can be assigned a centrality metric. This quantifies how important an AS-AS edge is in connections to the SaaS endpoint. In one embodiment, each edge may be assigned a centrality weight depending on the number of paths that pass through that edge. In another embodiment, the SECG graph can be converted to its dual graph (or Line-Graph) where each edge in the SECG is transformed to node, and there is an edge between two nodes if there was an ASN that is common between the edges of an ACG.
Sub-Path importance: The AS-path represents the entire list of paths of ASNs and parts of the paths that are important can be mined to assign connectivity importance. In one embodiment, each AS_Path is broken down into k-consecutive AS (e.g., AS1->AS2->AS3) and the weight of this 3- sequence can be found out by simple fraction of the paths that have such sequence. In other embodiments, this subpaths can be mined using sequential pattern mining algorithms such as PrefixSpan, to extract the most common sequence of AS that are present in all paths.

Note that the node, edge and sub-path centralities change over time, and ACGC 508 keeps track of the time-evolving data about the centralities of the above entities.

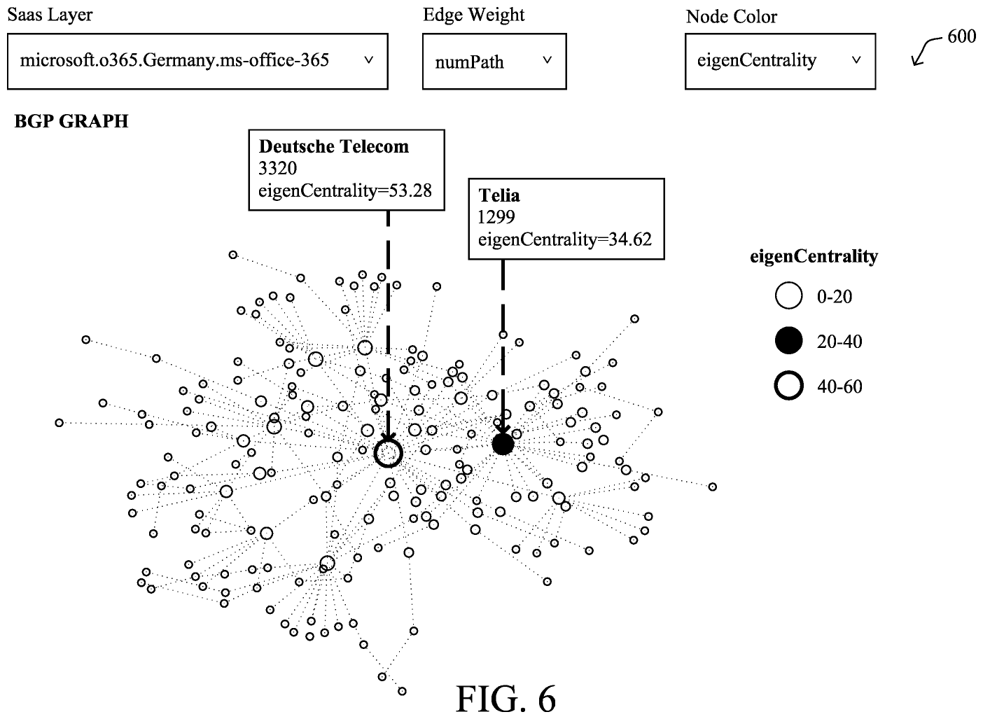

FIG. 6 illustrates an example SECG 600 to reach Office 365 datacenters in Germany. From SECG 600, it can be seen that AS3320 (Deutsche Telecom) is the most central node, and the edge between AS3320-AS1299 between Deutsche Telecom and Telia is most important edge.

Notably, SECG 600 is for one SaaS application in a particular region (e.g., Office 365 applications in Germany), with the most important ASNs belonging to Deutsche Telecom and Telia. As detailed below, this information can be used to troubleshoot the network and reroute traffic base on such connectivity importance.

Referring again to FIG. 5, core path alerter (CPA) 510 may be responsible for determining whether any QoE degradation for the application is attributable to any of the central nodes, edges or sub-paths. In addition, CPA 510 may be responsible for sending alerts to predictive application aware routing engine 412 and/or SaaS Provider device 516 regarding that core entity and the degraded application experience. To do so, CPA 510 may be responsible for first creating a mapping by assigning the application experience from ANC 502 to core connectivity entities of the SECG (such as central nodes, edges or sub-paths) computed by AGCG 508, and then performing correlation/causality analysis to check whether the application experience degradation is in fact attributable to any of the core entities.

In one embodiment, each core connectivity entity is assigned an application-experience metric for a period of time. The definition of a core-connectivity entity may be defined by utilizing the centrality metric. For example, a node, an edge or a sub-path is deemed as core if the centrality metric is greater than a certain threshold.

For each SaaS application data-center, CPA 510 may track the timeseries of the distribution of the application experiences metrics. A sudden change in the application experience is then determined by CPA 510 by examining this timeseries. For example, a timeseries can be constructed by taking the mean or other aggregate (say 10^{th} percentile) of the application experience metrics. Then, CPA 510 may apply a timeseries anomaly detection algorithm to it (e.g., tagging an application experience as ‘bad’ when it crosses the lower band of the time-series) or by applying statistical or machine learning anomaly algorithms to it (e.g., isolation forest), to detect a sudden drop in the experience metrics associated with the core entity.

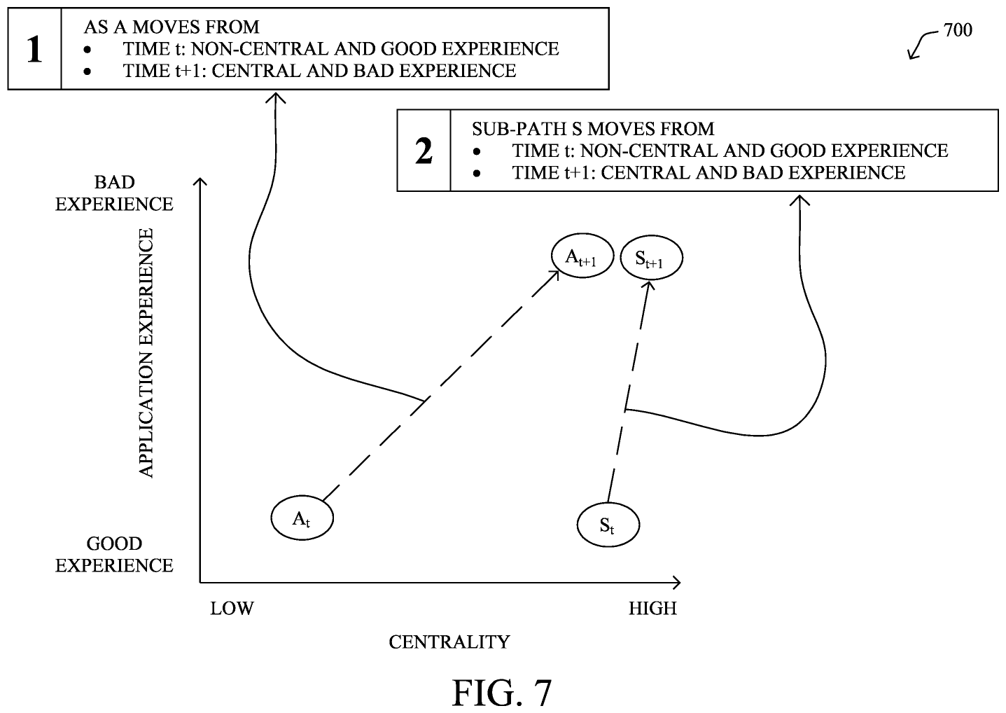

FIG. 7 illustrates an example plot 700 of application experience vs. entity centrality, according to various embodiments. As shown, plot 700 shows the progression over time of two entities: an autonomous system (AS) A and a sub-path S from time t to time t+1. Here, sub-path S over time moves from being central and offering good application experience to remaining central, but offering poor application experience. AS A, however, goes from offering good application experience and being of low centrality to having high centrality, but offering bad application experience.

Referring again to FIG. 5, CPA 510 may track the changes in both the measure of centrality and the application experience metrics of entities such as nodes, edges, and sub-paths over time, in various embodiments. In turn, CPA 510 may generate and provide any or all of the following types of alerts:
Bad-experience Alert: CPA 510 may generate this type of alert when an entity moves from providing good QoE metrics to bad QoE metrics. These can be alerts which indicate transition to bad experience irrespective of whether the entity is central or not. Predictive application aware routing engine 412 may act on this alert to search for better interfaces or paths which avoids such nodes or AS-AS edges.
Centrality change alert: CPA 510 may generate this type of alert when an entity moves from being non-central to being central or vice-versa. Such alerts may be used to prioritize the severity of application experience changes.
Central entity bad-experience alert: CPA 510 may generate this type of alert when an entity moves to bad experience state, as in the case of sub-path S in FIG. 7. In general, these are major alerts that indicate that something wrong has happened in the central routes. Such messages may be provided to either or both of predictive application aware routing engine 412 and SaaS Provider device 516, for purposes of alerting and troubleshooting.
Central change and bad-experience alert: A centrality change can happen when there are sudden routing changes, or when certain central sub-paths are suddenly detected. If such an event is also accompanied by transition to bad-experience, CPA 510 may also generate an alert that indicates that a severe anomaly has occurred that might impact multiple users.

In other embodiments, CPA 510 may correlate or use causal algorithms to ensure the precision of the alerts. For example, it may determine that the change in the application experience is highly correlated with the change in causality, before it sends a “Central change and Bad-experience” alert. This can be done using simple correlation metrics such as Pearson's correlation or by using time-series causality algorithms such as Granger's causality algorithm.

Another potential component in architecture 500 is route reconfiguration engine 512, which is typically executed by predictive application aware routing engine 412. Generally speaking, route reconfiguration engine 512 is responsible for receiving the alerts from CPA 510 and making routing decisions based on them. In one embodiment, route reconfiguration engine 512 receives various types of alerts and examines the type of alerts. If the alert is an application experience degradation at a non-central entity, then route reconfiguration engine 512 may search for other routes (e.g., other interfaces to send the application traffic), but to the same SaaS data-center.

In case of a “Central change and Bad-experience” alert, it may conclude that there is no point in changing the interfaces since the core connectivity entities have a bad experience to this SaaS data-center, and then change the SaaS data-center itself. When configured by the user, critical traffic sent through an arterial path that is severely impacting critical traffic may be explicitly rerouted along an alternate path. To that end various tunneling methodologies may be used. One strategy may be to encapsulate the traffic into a tunnel routed via a set of loose hops that will not traverse the impacted arterial path, such as by using Traffic Engineering Label Switched Paths (TE LSPs). Alternatively, the traffic may be sent to a destination from where the BGP graph shows that the traffic will no longer be routed onto the problematic arterial path.

Yet another potential component of architecture 500 is SaaS data center action engine 514, which also listens for alerts from CPA 510 and is responsible for taking appropriate actions to support good application experience when core connectivity is hampered. In one embodiment, SaaS data center action engine 514 may listen to only “Central change and Bad-experience” alerts. Upon receiving such an alert, SaaS data center action engine 514 may decide that many users may be impacted and might generated updated Domain Name System (DNS) information for the SaaS application, to redirect new sessions to a different data center. In addition, SaaS data center action engine 514 continue to receive updates from CPA 510, to keep monitoring the state of such core entities and may revert the DNS change, once it concludes that core entities are healthy.

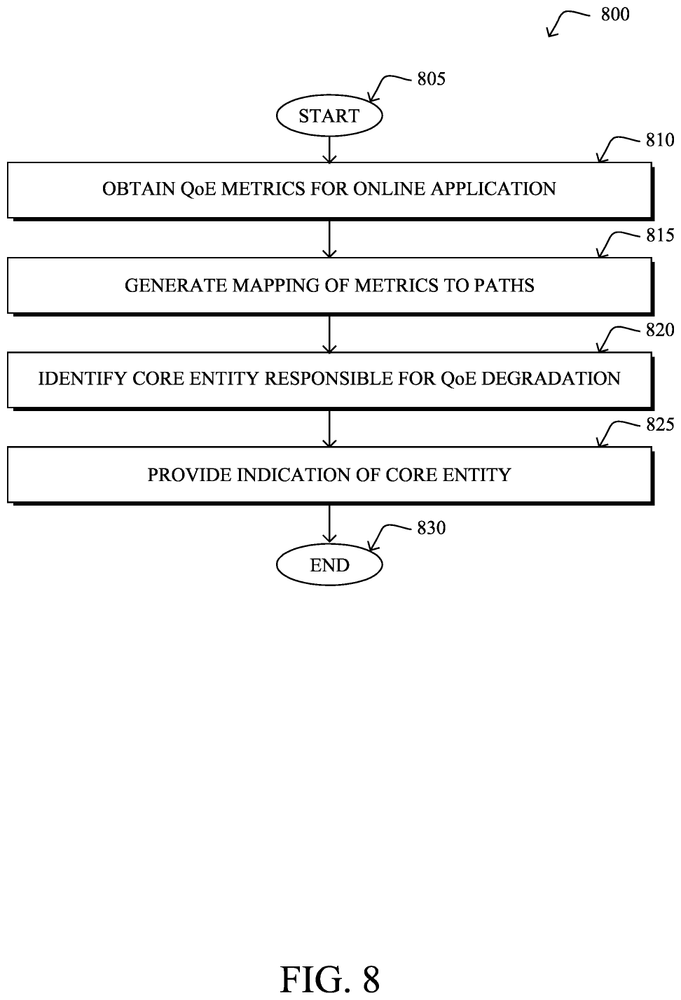

FIG. 8 illustrates an example simplified procedure 800 (e.g., a method) for identifying a core entity that is responsible for degradation of QoE metrics for an application, in accordance with one or more embodiments described herein. For example, a non-generic, specifically configured device (e.g., device 200), such as controller for a network (e.g., an SDN controller or other device in communication therewith), may perform procedure 800 by executing stored instructions (e.g., core network analysis process 249), to provide a supervisory service to a network. The procedure 800 may start at step 805, and continues to step 810, where, as described in greater detail above, the device may obtain quality of experience (QoE) metrics for an online application, such as a Software-as-a-Service (SaaS) application. For instance, the device may be specified by users of the online application (e.g., via a rating mechanism of the application, polling of the users, etc.) that can be obtained by the device from the provider of the application via an API or other suitable mechanism.

At step 815, as detailed above, the device may generate a mapping between network paths traversed by traffic of the online application and the QoE metrics. In some embodiments, the device may do so by constructing a routing graph with each node representing a different autonomous system and edges of the graph connecting different autonomous systems. In turn, the device may assign a weight to each node or edge, representing its importance. The device may then associate the QoE metrics to the different paths represented in the graph.

At step 820, the device may identify a core entity along the network paths that is responsible for degradation of the QoE metrics, as described in greater detail above. In various embodiments, the device may do so by assessing the network paths experiencing poor QoE that traverse the entity. If the number of such paths exceed a threshold amount, a threshold percentage, a threshold traffic volume, etc., this may indicate that the particular entity is responsible for the degradation. In further embodiments, the device may make this determination in part by weighting each node/entity in the routing graph based on its measure of centrality (e.g., a count of the number of the paths that pass through it, etc.). The device can then track the centrality of the graph nodes in relation to the quality of experience metrics. A central entity that is both central and responsible for poor QoE metrics may be of particular interest for purposes of generating alerts.

At step 825, as detailed above, the device may send an alert regarding the core entity. In various embodiments, the alert may cause the traffic of the online application to avoid the core entity. In one embodiment, the device may send the alert to an application-aware routing engine. In turn, that routing engine may reroute the traffic of the online application to avoid the core entity, based on the alert. In another embodiment, the device may send the alert to a provider of the online application. In turn, the provider may use DNS signaling to direct the traffic of the online application to a different data center, based on the alert, thereby avoiding the core entity. Procedure 800 then ends at step 830.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the identification of core entities (e.g., autonomous systems, etc.) that are responsible for a degradation in application quality of experience for an online application. In further aspects, the techniques herein also allow for the tracking and reporting of the ‘centrality’ of different entities when providing access to the application. In doing so, corrective measures can be taken to improve the application experience, such as by rerouting the application traffic, using DNS to point the traffic to other data centers, or the like.

While there have been shown and described illustrative embodiments that provide for detecting critical regions and paths in the core network for application-driven predictive routing, it is to be understood that various other adaptations and modifications may be made within the spirit and scope of the embodiments herein. For example, while certain embodiments are described herein with respect to using certain models for purposes of predicting application experience metrics, SLA violations, or other disruptions in a network, the models are not limited as such and may be used for other types of predictions, in other embodiments. In addition, while certain protocols are shown, other suitable protocols may be used, accordingly.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

1. A method comprising:
obtaining, by a device, quality of experience metrics for an online application;
generating, by the device, a mapping between network paths traversed by traffic of the online application and the quality of experience metrics;
identifying, by the device, a core entity along the network paths that is responsible for degradation of the quality of experience metrics; and
sending, by the device, an alert regarding the core entity, wherein the alert causes the traffic of the online application to avoid the core entity.

2. The method as in claim 1, wherein the core entity is a particular autonomous system.

3. The method as in claim 1, wherein the device obtains the quality of experience metrics for the online application from a provider of the online application.

4. The method as in claim 1, wherein the quality of experience metrics are specified by users of the online application.

5. The method as in claim 1, wherein identifying the core entity along the network paths that is responsible for degradation of the quality of experience metrics comprises:
determining a measure of centrality for the core entity that is based in part on a count of the network paths traversed by traffic of the online application that pass through the core entity.

6. The method as in claim 5, further comprising:
sending, by the device, an alert indicative of the measure of centrality for the core entity, when the measure of centrality changes for the core entity.

7. The method as in claim 1, wherein the device sends the alert to an application-aware routing engine.

8. The method as in claim 7, wherein the application-aware routing engine reroutes the traffic of the online application to avoid the core entity, based on the alert.

9. The method as in claim 1, wherein the device sends the alert to a provider of the online application.

10. The method as in claim 9, wherein the provider of online application uses Domain Name System (DNS) signaling to direct the traffic of the online application to a different data center, based on the alert.

11. An apparatus, comprising:
one or more network interfaces;
a processor coupled to the one or more network interfaces and configured to execute one or more processes; and
a memory configured to store a process that is executable by the processor, the process when executed configured to:
obtain quality of experience metrics for an online application;
generate a mapping between network paths traversed by traffic of the online application and the quality of experience metrics;
identify a core entity along the network paths that is responsible for degradation of the quality of experience metrics; and
send an alert regarding the core entity, wherein the alert causes the traffic of the online application to avoid the core entity.

12. The apparatus as in claim 11, wherein the core entity is a particular autonomous system.

13. The apparatus as in claim 11, wherein the apparatus obtains the quality of experience metrics for the online application from a provider of the online application.

14. The apparatus as in claim 11, wherein the quality of experience metrics are specified by users of the online application.

15. The apparatus as in claim 11, wherein the apparatus identifies the core entity along the network paths that is responsible for degradation of the quality of experience metrics by:
determining a measure of centrality for the core entity that is based in part on a count of the network paths traversed by traffic of the online application that pass through the core entity.

16. The apparatus as in claim 15, wherein the process when executed is further configured to:
send an alert indicative of the measure of centrality for the core entity, when the measure of centrality changes for the core entity.

17. The apparatus as in claim 11, wherein the apparatus sends the alert to an application-aware routing engine.

18. The apparatus as in claim 17, wherein the application-aware routing engine reroutes the traffic of the online application to avoid the core entity, based on the alert.

19. The apparatus as in claim 11, wherein the apparatus sends the alert to a provider of the online application.

20. A tangible, non-transitory, computer-readable medium storing program instructions that cause a device to execute a process comprising:
obtaining, by the device, quality of experience metrics for an online application;
generating, by the device, a mapping between network paths traversed by traffic of the online application and the quality of experience metrics;
identifying, by the device, a core entity along the network paths that is responsible for degradation of the quality of experience metrics; and
sending, by the device, an alert regarding the core entity, wherein the alert causes the traffic of the online application to avoid the core entity.
